(19) United States
(12) Patent Application Publication
(10) Pub. No.: US 2015/0176703 A1
(43) Pub. Date: Jun. 25, 2015

(54) DEVICE FOR MOUNTING IN A SUPPORT HOUSING A TRANSMISSION AND SELECTION ELEMENT SECURED TO A CONTROL LEVER OF A MOTOR VEHICLE MECHANICAL GEAR BOX

(71) Applicant: DURA AUTOMOTIVE SYSTEMS SAS, Bievres (FR)

(72) Inventor: Philippe Pradier, Sorbiers (FR)

(73) Assignee: DURA AUTOMOTIVE SYSTEMS SAS, Bievres (FR)

(21) Appl. No.: 14/417,102

(22) PCT Filed: Jul. 18, 2013
(86) PCT No.: PCT/FR2013/051744

§ 371 Date: Jan. 23, 2015

(30) Foreign Application Priority Data
Jul. 24, 2012 (FR) 1257174

(51) Int. Cl. F16H 61/18; F16H 59/04

(52) U.S. Cl. CPC F16H 61/18; F16H 59/042; F16H 2061/185

(57) ABSTRACT

The element is mounted such that it pivots in relation to an axis and is secured to a selector finger that is connected to the lever to provoke the pivoting of the element under the effect of an angular tilt. It comprises, at the swivel axis of the said element, a cam profile that has a part of the said element, the said profile interacting with a flexible returning member for creating, depending on the angular position of the selection element and the area under consideration of the cam profile, a resistance with an intensity varying up to the creation of a hard spot corresponding to the selection of the reverse gear.

### BACKGROUND

1. Technical Field

The invention relates to the technical sector of equipment for motor vehicles and more particularly to the selection control of gearboxes, especially mechanical gearboxes.

2. Description of the Related Art

It should be recalled, for a better understanding of the following description, that the gear selection and shifting control is engaged by means of a mounted lever with a capacity for angular displacement in a support housing that is generally attached in the motor vehicle cabin. This housing is designed for the mounting, such that the lever is capable of moving in multiple directions, especially in the form of a spherical joint such as a ball and socket joint. The lower end of the lever is designed to generally ensure, with the transmission elements, gear selection and shifting through cables or bars.

For example, the ball and socket joint of the lever is connected with a selector finger that is fitted to rotate freely in the transmission and selection element, such that the angular tilting of the lever concomitantly causes the angular pivoting of the transmission and selection element that is mounted with capacity of articulation with respect to an axis. Note that the axis is generally fitted with a hairpin spring that is mounted under pretension, and the branches of which are stimulated separately, under the effect of the angular tilting of the lever.

It is also known that it is necessary to design the gear selection in order to avoid unexpectedly engaging the reverse gear, especially when the lever is tilted to the right in order to align it with the 1-2 gear lane or tilted to the left to be in alignment with the 5-6 gear lane. For example, the control lever can be fitted with a reverse gear locking system in the form of a trigger that can be manually operated to allow angular movement of the lever. When the trigger is not actuated, it is possible to angularly guide and tilt the lever corresponding to the selection, and, for example, the switching from the first gear. In this non-actuated position of the trigger, it is not possible to guide the lever further to select the reverse gear. Therefore, to engage the reverse gear, it is necessary to actuate the trigger to release a stop, thus allowing the gear lever to make a larger movement. These means can be found in the 5-6 gear lane. This trigger solution for locking the reverse gear naturally causes significant additional costs.

Having this same objective of avoiding any untimely engaging of the reverse gear, a proposal has been made to create a hard spot at the control lever. This hard spot may be located at the 1-2 gear shift lane towards the MAR lane or at the 5-6 gear shift lane towards the MAR lane. E.g., this hard spot can be created by a boss that has the transmission and selection element, and which is connected with a leaf spring. With this form of execution, the transmission and selection element returns to its position via a pre-tensioned hairpin spring fitted around the swivel axis of the said transmission and selection element.

From this state of the art, the problem that the invention seeks to solve is the suggestion of a safety mechanism for the reverse gear, established by creating a hard spot, the objectives of which are to significantly reduce costs and remove the pre-tensioned return hairpin spring fitted around the swivel axis of the selection element.

### BRIEF SUMMARY

To solve this problem, a device has been designed and developed in a support housing, which is used for mounting a transmission and selection element secured to a control lever of a mechanical gearbox of a motor vehicle, and which comprises, at the articulation axis of the said element, a cam profile that has a part of the said element, the said profile being connected with a flexible returning member for creating, depending on the angular position of the selection element and the area under consideration of the cam profile, a resistance with an intensity varying up to the creation of a hard spot corresponding to the selection and switching of the reverse gear.

It therefore results from these characteristics that the returning member, in combination with the cam profile of a part of the transmission and selection element, simultaneously ensures the function of the hard spot for engaging the reverse gear and allows returning the said transmission and selection element to the neutral position.

In another form of execution, the flexible returning member is a leaf spring fixed in a plane that is at a slight tangent to the swivel axis of the transmission element, on one part of the support housing that contains the control lever.

From these characteristics, it is particularly important to note that this leaf spring may actively contribute to effectively and rationally ensuring the synchronization between the neutral position of the control lever and the neutral position of the gearbox.

To achieve this objective, and according to the invention, the leaf is mounted, before fixing, with the ability to move in translation, in order to ensure the synchronization between the neutral position of the control lever and that of the gearbox.

For this purpose, the leaf has an oblong aperture that interacts with a fixing member on the part of the support housing.

From this layout, it results that at the time of coupling the cables or bars at the transmission and selection elements and in the neutral position of the control lever and the gearbox, the screw on the leaf spring is not tightened so that the latter, via its oblong aperture, can follow the free movements of the lever and the cam, and it is only when the synchronization is ensured that the screw is tightened in the oblong aperture of the leaf.

### BRIEF DESCRIPTION OF THE SEVERAL VIEWS OF THE DRAWINGS

The invention is explained more in detail hereinafter, with the help of the figures given in the annex, in which:

FIG. 1 is a perspective view of a form of execution, given for information purposes only and in no way limiting, of a support housing with the control lever and transmission and selection element,

FIG. 2 is a partial view, at a larger scale, of the transmission and selection element,

FIGS. 3 to 10 show the position of the transmission and selection element according to the angular tilt of the lever corresponding to a selection of a gear shift lane, wherein:

FIG. 3 shows the transmission and selection element in the neutral position of the lever,

FIG. 4 is a partial view, at a larger scale, corresponding to FIG. 3,

FIG. 5 shows the transmission and selection element corresponding to a tilt of the lever according to the 5-6 gear shift lane,

FIG. 6 is a partial view, at a larger scale, corresponding to FIG. 5,

FIG. 7 shows the position of the transmission and selection element corresponding to a lever position according to the 1-2 gear lane,

FIG. 8 is a partial view, at a larger scale, corresponding to FIG. 7,

FIG. 9 shows the transmission and selection element in the lever position corresponding to the hard spot for selecting the reverse gear,

FIG. 10 is a partial view, at a larger scale, corresponding to FIG. 9,

FIGS. 11, 12 and 13 show the different phases of adjustment of the synchronization between the neutral of the lever and the neutral of the gearbox

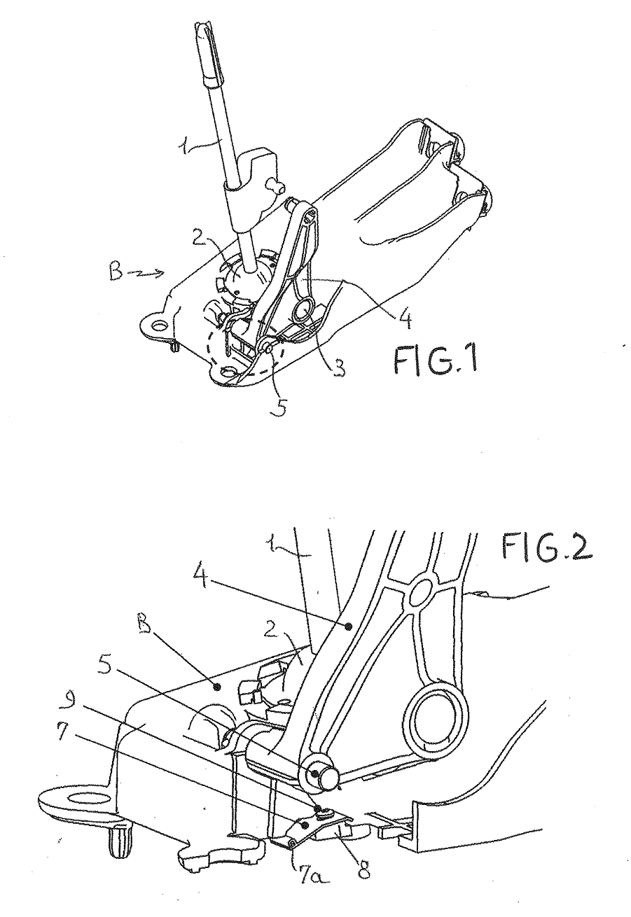

FIG. 1 shows an example of a housing (B) of a mechanical gearbox containing, with the capacity of articulation, a control lever (1) for switching and selecting gears via cables, for example. E.g., the mounting of the lever (1) with the capacity of multidirectional movement is executed via a ball and socket joint (2) that may have a finger (3) serving as an axis for the coupling of a transmission and selection element (4). The angular tilt of the lever (1) to the left or the right with respect to a neutral position causes, through the selector finger (3), the angular pivoting of the transmission and selection element (4) with respect to a rotation axis (5). These arrangements are not described in detail as they are known perfectly by the person skilled in the art.

According to another characteristic of the invention, the desired purpose is to create a hard spot for selecting and switching from the reverse gear, either at the 1-2 gear lane, or at the 5-6 gear lane.

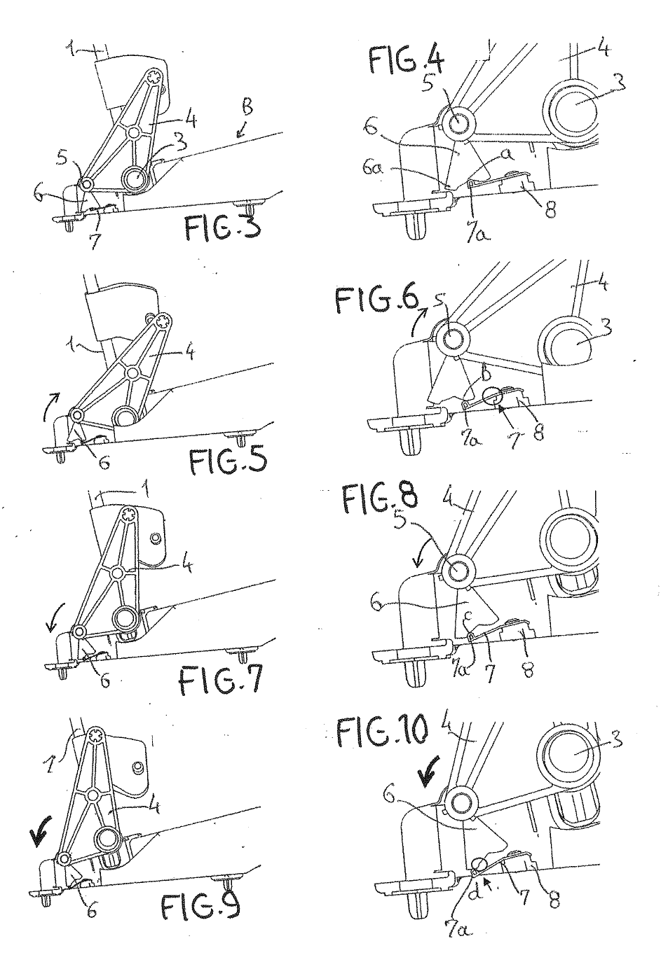

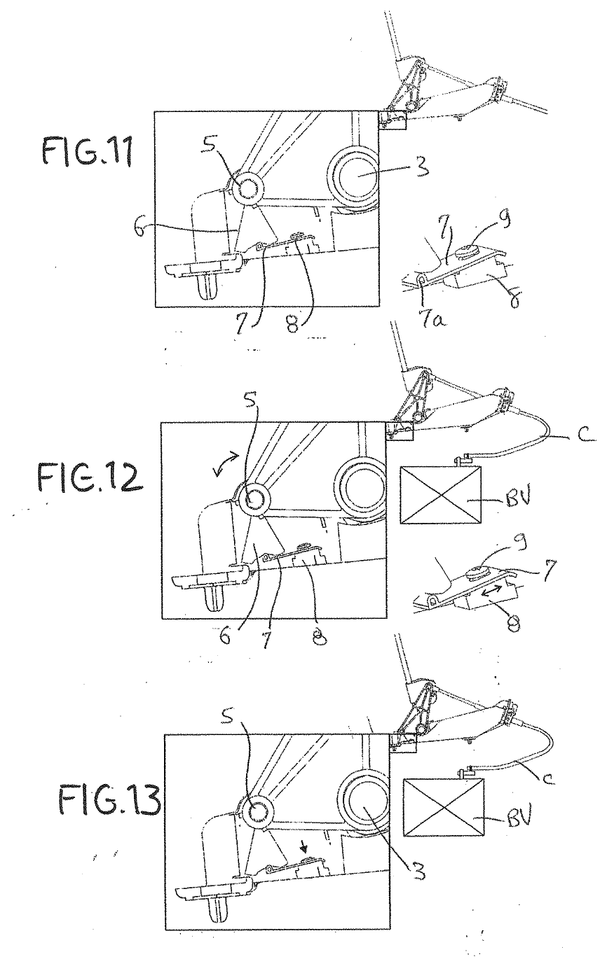

The transmission and selection element (4) has, at its swivel axis (5), a cam profile (6) that is able to interact with a flexible returning member (7) to create, depending on the angular position of the transmission and selection element (4) and the area in consideration of the cam, a hard spot at the lever for switching from the reverse gear. The cam profile (6a) has an area (a) corresponding to the neutral position of the lever (FIGS. 3 and 4), an area (b) corresponding to the lever position according to the 5-6 gear lane (FIGS. 5 and 6), an area (c) corresponding to the lever tilt on the 1-2 gear lane (FIGS. 7 and 8) and an area (d) corresponding to the tilt of the lever towards the reverse gear (FIGS. 9 and 10). Therefore, the cam profile actually constitutes the hard spot between areas (c) and (d). In other words, in the figures of the drawings given in the Annex, the hard spot is located at the 1-2 gear lane. Keep in mind that this hard spot may be located at the 5-6 gear lane.

The flexible returning member (7) comprises a leaf spring fixed in a plane that is tangent to the swivel axis (5) of the transmission element (4), on one fixed part (8) of the support housing (B) that contains the control lever (1). The free end of the leaf (7) has an arrangement, e.g., in the form of a roller (7) that is capable of interacting with the cam profile (6a) of the transmission and selection element (4).

FIGS. 3 to 10 show the different positions of the transmission and selection element (4) and consequently the cam profile (6) with respect to the angular tilt of the lever.

In FIGS. 3 and 4, the lever is in the neutral position, and the area (a) of the cam profile (6a) interacts with the end (7a) of the leaf spring (7).

In FIGS. 5 and 6, the lever (1) is actuated and tilts angularly, thus causing, via the selector finger (3), the angular pivoting (arrow F) of the transmission and selection element and the positioning of the cam profile area (b) with the end (7a) of the leaf (7).

In FIGS. 7 and 8, the lever (1) is tilted in the opposite direction as compared to what is shown in FIGS. 5 and 6, in order to select the 1-2 gear lane. The transmission and selection element (4) pivots at an angle around its axis (5) (arrow F1) so that only the area (c) of the cam profile is in contact with the end (7a) of the leaf (7).

In FIGS. 9 and 10, to be released from the hard spot located between the areas (c) and (d) of the cam profile, it is necessary to exert a tilting effort on the lever in the same direction as what is shown in FIGS. 7 and 8, but with a greater intensity, in order to overcome this hard spot and position, under the effect of the angular pivoting of the transmission element (4), the area (d) of the cam profile (6a) with the end (7a) of the leaf (7) corresponding to the shifting and selection of the reverse gear.

As shown, it is important to determine the cam profile (6a) in order to voluntarily adapt the force that must be exerted on the lever (1) and therefore, on the transmission and selection element, depending on the desired gear shift lane.

From the given characteristics, it is observed that the leaf spring (7) interacts with the cam profile of the transmission and selection element, which ensures that this element returns to its position, thus eliminating the use of the pre-tensioned return spring mounted according to the state of the art around the swivel axis of the transmission and selection element.

According to an important characteristic of the invention, the special mounting device of the control and selection element (4) also helps in effectively and easily ensuring the synchronization between the neutral of the control lever (1) and that of the gearbox. This synchronization is very important and normally requires complex means of implementation.

According to the invention, the return leaf spring (7) of the transmission and selection element (4) is fixed beforehand in the part (8) of the housing with a limited ability to move in translation. For this purpose, the leaf (7) is fixed on the part (8) of the support using a screw (9) that is engaged in an oblong aperture that is formed within the said leaf (7). Moving on to FIGS. 11, 12 and 13.

From these, it can be seen that before coupling the cables (C) to the gearbox (BV), the lever (1), and consequently the transmission and selection element (4) with the cam (6), are completely free, so that the return leaf spring (7) can be freely moved in one direction or the other (arrow F2), provided that the screw (9) is not tightened.

Once the cables are connected to the gearbox (FIG. 12), the entire transmission and selection element with the cam (6) and the leaf (7) can be moved, such that after having adjusted the synchronization, it is enough to simply fix the selected position by retightening the screw (9) in order to ensure that the leaf (7) is locked in position with respect to the part (8) of the support (FIG. 13), thus ensuring the perfect neutral position synchronization of the lever and the gearbox.

The advantages are quite evident from the description. The following points ought to be highlighted:
The simplified execution of a hard spot by the leaf spring that interacts with a specific cam profile, the said leaf also ensuring the return of the transmission and selection element to its position, thus eliminating the need for a hairpin torsion spring.
The adjustment of the synchronization between the neutral of the lever and the neutral of the gearbox by means of the leaf spring of the transmission and selection element.
The reduced cost of production.
The ease of assembly.
The effectiveness of the obtained result.
The simplicity of execution.
The obtaining of a non-linear return effort by means of the cam.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device for a motor vehicle comprising: a mounting device in a support housing for a transmission element secured to a control lever of a mechanical gearbox of a motor vehicle, the transmission element being mounted such that it pivots with respect to an axis and is secured to a selector finger connected to the control lever to provoke the pivoting of the transmission element under an angular tilting effect, wherein the transmission element has, a cam profile, the cam profile interacting with a flexible returning member for creating, depending on the angular position of the transmission element and the area under consideration of the cam profile, a resistance with an intensity varying up to the creation of a hard spot corresponding to the selection and shifting of the reverse gear.

2. The device according to claim 1 wherein the flexible returning member is a leaf spring fixed in a plane that is at a slight tangent to the swivel axis of the transmission element, on one part of the support housing that contains the control lever.

3. The device according to claim 2 wherein the free end of the leaf spring is designed such that it is capable of interacting with the cam profile of the transmission element.

4. The device according to claim 3 wherein the leaf spring is mounted, before fixing, with the ability to move in translation, in order to ensure the synchronization between the neutral position of the control lever and that of the gearbox.

5. The device according to claim 4 wherein the leaf spring has an oblong aperture that interacts with a fixing member on the part of the support housing.

6. The device according to claim 1 wherein the hard spot is located in the 1-2 gear lane going towards the rear gear lane.

7. The device according to claim 1 wherein the hard spot is located in the 5-6 gear lane going towards the rear gear lane.
